(19) United States
(12) Patent Application Publication
(10) Pub. No.: US 2026/0228086 A1
(43) Pub. Date: Aug. 6, 2026

(54) SYSTEM AND METHOD FOR AUTOMATED PATH DISCOVERY OF JOINABLE TABLES IN DATABASE BACKUPS

(71) Applicant: Eon IO, Ltd., Tel Aviv (IL)

(72) Inventors: Orly AMIR, Ramat Gan (IL); Assaf NATANZON, Tel Aviv (IL); Ilya SURDIN, Ramat Gan (IL); Ron KIMCHI, Tel Aviv (IL); Yaniv PTASHNIK, Tel Mond (IL); Ofir EHRLICH, Tel Aviv (IL)

(73) Assignee: Eon IO, Ltd., Tel Aviv (IL)

(21) Appl. No.: 19/076,589

(22) Filed: Mar. 11, 2025

Related U.S. Application Data
(63) Continuation-in-part of application No. 19/042,474, filed on Jan. 31, 2025.

(51) Int. Cl. G06F 11/14; G06F 16/22

(52) U.S. Cl. CPC G06F 11/1448; G06F 16/2282

(57) ABSTRACT

A method and system for constructing a join graph from normalized data are provided. The method includes receiving normalized data derived from a plurality of database tables, wherein the normalized data corresponds to columns that have been standardized to a format across the plurality of database tables; identifying one or more unique identifier columns among the plurality of database tables in the normalized data, wherein each unique identifier column includes values that enable matching of data across the plurality of database tables; generating a plurality of graph nodes, each node corresponding to at least one of the plurality of database tables; mapping joinable relationships between the graph nodes based on the unique identifier columns; and generating a join graph based on the mapped joinable relationships.

### CROSS-REFERENCE TO RELATED APPLICATION(S)

This application is a continuation-in-part of and claims the benefit of priority under 35 U.S.C. § 120 to U.S. patent application Ser. No. 19/042,474, filed on Jan. 31, 2025, entitled “System and Method for Performing Join Operations in Digital Backups of Database Applications.” The subject matter of the aforementioned application is hereby incorporated by reference in its entirety for all purposes.

### TECHNICAL FIELD

The present disclosure relates generally to digital backup and restoration and, more specifically, to systems and methods for automated path discovery of joinable tables in database backups across multiple database tables.

### BACKGROUND

Database backup refers to creating copies of data so that the data can be restored or recovered in the event of corruption, deletion, hardware failure, or other issues. Traditional backup solutions often focus on capturing an entire database's contents using methods such as full, incremental, or differential backups, but they generally do not provide robust features for querying or correlating backed-up data from multiple database sources.

Databases may be of different types (for example, SQL vs. NoSQL), versions, or vendors (for example, MySQL, PostgreSQL, MongoDB, and so forth). Conventional backup systems generally do not enable cross-database operations on backed-up data. Even if a user wants to join data from one backup to another, each database typically must be restored separately and then merged or imported into a single environment. This manual process can be time-consuming and impractical, especially for large or heterogeneous data sets.

In one approach, column unification, data normalization, and similarity detection (for example, MinHash) can be used to identify and join related columns across multiple backups. By categorizing columns (for example, first name, last name, IP address), converting different data formats to a unified standard, and detecting value overlap through hashing, backups from multiple database engines can be made joinable more efficiently.

Although this approach supports joining columns that are directly related, further challenges arise when a user's query spans multiple tables or involves multiple steps. For example, a request may require combining a user's personal data in one table, payment credentials in a second table, and transaction records in a third table. Identifying the optimal join paths across thousands of tables manually is both cumbersome and error-prone.

It would, therefore, be advantageous to provide a solution that would facilitate the discovery of paths across multiple joinable tables, thereby allowing more complex queries on backed-up data.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, the method may include receiving normalized data derived from a plurality of database tables, where the normalized data corresponds to columns that have been standardized to a format across the plurality of database tables. The method may also include identifying one or more unique identifier columns among the plurality of database tables in the normalized data, where each unique identifier column includes values that enable matching of data across the plurality of database tables. The method may furthermore include generating a plurality of graph nodes, each node corresponding to at least one of the plurality of database tables. The method may, in addition include mapping joinable relationships between the graph nodes based on the unique identifier columns. The method may moreover include generating a join graph based on the mapped joinable relationships. Other embodiments of this aspect include corresponding computer systems, apparatus, and computer programs recorded on one or more computer storage devices, each configured to perform the actions of the methods.

Implementations may include one or more of the following features. The method may include: storing metadata for each standardized column, where the metadata includes at least one of: an original column name for the column, and a normalizing rule applied to the column. The method may include: computing hash-based signatures for at least two columns in the normalized data and designating the columns as unique identifier columns upon determining that the columns share a threshold overlap in their computed hash-based signatures. The method may include: receiving a query referencing multiple tables in the normalized data, traversing the join graph to find a multi-hop path between at least two of the graph nodes, and returning joined query results based on the multi-hop path. The method may include: dividing at least one large database table into multiple subsets in the normalized data, each subset corresponding to a distinct range of retrieval key values. The method may include: storing the generated join graph along with the normalized data in a backup repository, thereby enabling subsequent queries to reuse the join graph. The method where identifying the one or more unique identifier columns includes detecting columns with personally identifiable information for enabling record matching across multiple tables. The method may include: applying a large language model or generative AI system to determine standardized column categories prior to receiving the normalized data. The method may include: normalizing columns originating from at least one relational database and at least one non-relational database to unify columns for cross-database join operations. The method may include: creating a joined table by merging data from multiple nodes in the join graph and storing the joined table in a same repository as the normalized data. Implementations of the described techniques may include hardware, a method or process, or a computer tangible medium.

In one general aspect, non-transitory computer-readable medium may include one or more instructions that, when executed by one or more processors of a device, cause the device to: receive normalized data derived from a plurality of database tables, where the normalized data corresponds to columns that have been standardized to a format across the plurality of database tables; identify one or more unique identifier columns among the plurality of database tables in the normalized data, where each unique identifier column includes values that enable matching of data across the plurality of database tables; generate a plurality of graph nodes, each node corresponding to at least one of the plurality of database tables; map joinable relationships between the graph nodes based on the unique identifier columns. The non-transitory computer-readable medium may also include generating a join graph based on the mapped joinable relationships. Other embodiments of this aspect include corresponding computer systems, apparatus, and computer programs recorded on one or more computer storage devices, each configured to perform the actions of the methods.

In one general aspect, the system may include one or more processors configured to: receive normalized data derived from a plurality of database tables, where the normalized data corresponds to columns that have been standardized to a format across the plurality of database tables; identify one or more unique identifier columns among the plurality of database tables in the normalized data, where each unique identifier column includes values that enable matching of data across the plurality of database tables. The system may in addition include generating a plurality of graph nodes, each node corresponding to at least one of the plurality of database tables. The system may moreover include map joinable relationships between the graph nodes based on the unique identifier columns. The system may also include generating a join graph based on the mapped joinable relationships. Other embodiments of this aspect include corresponding computer systems, apparatus, and computer programs recorded on one or more computer storage devices, each configured to perform the actions of the methods.

Implementations may include one or more of the following features. The system where the one or more processors are further configured to: store metadata for each standardized column, where the metadata includes at least one of: an original column name for the column, and a normalizing rule applied to the column. The system where the one or more processors are further configured to: compute hash-based signatures for at least two columns in the normalized data and designating the columns as unique identifier columns upon determining that the columns share a threshold overlap in their computed hash-based signatures. The system where the one or more processors are further configured to: receive a query referencing multiple tables in the normalized data, traversing the join graph to find a multi-hop path between at least two of the graph nodes, and returning joined query results based on the multi-hop path. The system where the one or more processors are further configured to: divide at least one large database table into multiple subsets in the normalized data, each subset corresponding to a distinct range of retrieval key values. The system where the one or more processors are further configured to: store the generated join graph along with the normalized data in a backup repository, thereby enabling subsequent queries to reuse the join graph. The system where identifying the one or more unique identifier columns includes detecting columns with personally identifiable information for enabling record matching across multiple tables. The system where the one or more processors are further configured to: apply a large language model or generative AI system to determine standardized column categories prior to receiving the normalized data. The system where the one or more processors are further configured to: normalize columns originating from at least one relational database and at least one non-relational database to unify columns for cross-database join operations. The system where the one or more processors are further configured to: create a joined table by merging data from multiple nodes in the join graph and storing the joined table in a same repository as the normalized data. Implementations of the described techniques may include hardware, a method or process, or a computer tangible medium.

Embodiments of the present disclosure may be provided as a network of communicating devices (i.e. a “computerized network”). Embodiments of the invention may also be provided as a software application downloadable into a computer device to facilitate the method. The software application may be a computer program product, which may be stored on a non-transitory computer-readable medium on a tangible data-storage device (such as a storage device of a server, or one within a user device).

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

In the drawings:

FIG. 1 is a network diagram including a database backup environment, in accordance with an embodiment of the present disclosure.

FIG. 2 is a flowchart of a method for generating a database backup and performing data normalization, in accordance with an embodiment of the present disclosure.

FIG. 3 is a flowchart of a method for creating a joinable database backup, in accordance with an embodiment of the present disclosure.

FIG. 4 is a flowchart of a method for constructing a join graph from normalized backup data, in accordance with an embodiment of the present disclosure.

FIG. 5 is a flowchart of a method for traversing the join graph and automatically generating a composite query based on a user input, in accordance with an embodiment of the present disclosure.

FIG. 6 is a diagram illustrating a join graph in which nodes represent unique identifier columns and arrows represent the direction of traversal between joinable columns, in accordance with an embodiment of the present disclosure.

FIG. 7 is a schematic diagram of a backup system architecture, in accordance with an embodiment of the present disclosure.

### DETAILED DESCRIPTION

It is important to note that the embodiments disclosed herein are examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

Database backup is the process of creating copies of data to protect against data loss, corruption, or hardware failure. Backups ensure that information can be restored if something goes wrong, maintaining data availability and minimizing downtime. There are several types of backups used to meet different recovery needs. A full backup captures the entire database, offering a complete snapshot of a specific point in time. Incremental backups, on the other hand, store only the changes made since the last backup, making them more space-efficient but requiring all previous backups for a full restoration. Differential backups store changes made since the last full backup, striking a balance between efficiency and ease of recovery.

Cloud-based databases can be implemented as managed databases, such as Amazon® RDS, or by deploying a virtual machine, such as an Amazon® EC2 instance with a database application installed thereon. Such a machine can include many temporary files that may consume significant storage resources. Additionally, an older database backup may utilize a previous version of the database application, and restoring such an outdated backup may pose cybersecurity risks due to known vulnerabilities in the older software.

The disclosed embodiments enable join operations on databases of the same types, different types, or with the same database and searching for related tables to join. A join operation in a database is used to combine rows from two or more tables based on a related column between them. According to an embodiment, the join operation is enabled on a database backup generated in an efficient manner to solve a number of technical problems, such as slow backup and recovery, and slow execution of join operations. It should be emphasized that currently there is no solution in the related art that allows for performing join operations among multiple tables residing in different databases of different types (e.g., MySQL and MongoDB).

The disclosed embodiments support join operations across multiple tables from the same or different databases by normalizing the data and unifying the naming of columns. The join operation is performed by searching for columns in different tables with substantially similar content and joining such columns. The search is performed on precomputed hash values that allow fast operation while saving on computational resources.

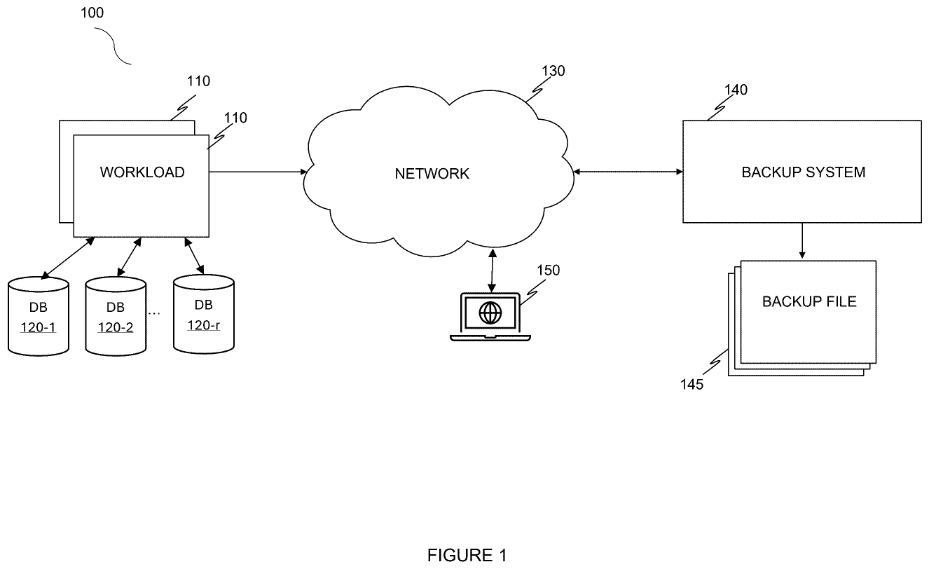

FIG. 1 is a network diagram including a database backup environment, in accordance with an embodiment of the present disclosure. As illustrated in FIG. 1, a plurality of databases 120-1, 120-2, . . . , 120-r are backed up by the backup system 140 into backup files 145. In some embodiments, backup system 140 further processes these backup files to generate unified column metadata, normalized data values, and precomputed hash values. These data elements are subsequently used to construct a join graph that facilitates automated path discovery of joinable tables across heterogeneous databases.

Database 120 may include a database application, a database management system (DBMS), a combination thereof, and the like. In some embodiments, a database 120 may be a column-oriented database, a relational database, a tabular relational database, a document-oriented database, and the like. For example, database 120-1 may be implemented using MySQL, and database 120-2 may be implemented using MongoDB. In an embodiment, database 120 may include metadata, such as a database schema. In some embodiments, the database schema includes a data structure, such as a table, including a plurality of keys, at least a portion of which corresponds to columns of the table.

In certain embodiments, the databases 120 are deployed on one or more workloads 110. In an embodiment, workload 110 is a physical computing device, a virtual computing device (e.g., a virtual machine), or a combination thereof. In some embodiments, a workload 110 is a software container. In an embodiment, a software container is deployed on a software container platform, such as Kubernetes®, Docker®, and the like.

According to an embodiment, a workload 110 is implemented as a virtual machine, a software container, a serverless function, or a combination thereof. In some embodiments, a database 120 is implemented as a managed database, for example utilizing Amazon® RDS. In an embodiment, a virtual machine is deployed as an Amazon® EC2 instance. A software container is deployed on a container platform such as Kubernetes®, Docker®, and the like. In some embodiments, a serverless function is deployed as an Amazon® Lambda function.

In an embodiment, workload 110 is configured to provide access to database 120, for example, over a network 130. In some embodiments, a cloud computing infrastructure is implemented on network 130. For example, in an embodiment, a cloud computing infrastructure is provided by Amazon® Web Services (AWS), Google® Cloud Platform (GCP), Microsoft® Azure, and the like. In certain embodiments, the cloud computing infrastructure is utilized to deploy a cloud computing environment. In an embodiment, a cloud computing environment is a virtual private cloud (VPC), a virtual network (VNet), a virtual private network (VPN), or a combination thereof.

In some embodiments, workload 110 is configured to provide access to database 120 to a database backup system 140 (also referred to as backup system 140). In an embodiment, backup system 140 is configured to generate a backup of databases 120. In an embodiment, backup system 140 is implemented as a virtual machine, a software container, a serverless function, or a combination thereof.

In an embodiment, backup system 140 is configured to generate a backup of a database by determining a retrieval key of database 120. For example, the data backup may include only the database data, such as data exported from the database, a database schema, or a combination thereof.

According to an embodiment, data and information that enables the generation of a restored machine include a filesystem, a directory, a registry, configuration information, software product keys, or a combination thereof. For example, in one embodiment, a machine backup includes an identifier of an operating system (such as Windows®, Linux®, etc.), an identifier of a database application (e.g., Apache® Derby), a filesystem, a registry file, a configuration file, or a combination thereof.

Backup system 140 is configured to generate a restored database from the backup files 145. The restored database contains the original data present prior to the backup, regardless of any changes made during the backup process.

In an embodiment, backup system 140 is configured to generate a data backup based on the data stored in database 120. In certain embodiments, the data backup includes a plurality of backup files 145. In an embodiment, the backup files 145 are a plurality of data files stored in a column-oriented format. A column-oriented data file is, for example, Apache® Parquet. In an embodiment, the values of each column of the database are stored in serial, contiguous memory locations, which provide several benefits, such as improved column-wise compression and reduced query execution processing by reading only the relevant columns rather than an entire row of data.

Backup system 140 may be configured to determine a retrieval key of the database. The retrieval key may be any key, value, keyword, or index. To this end, backup system 140 is configured to generate a plurality of queries based on the retrieval key, with each query returning a plurality of rows of data from the database. The resulting rows may be stored in at least one column-oriented data file, e.g., the backup files 145.

According to an embodiment, a retrieval key is a database key that includes values that are unique for each row. For example, a retrieval key is, in one embodiment, an index value. As no two rows can have the same index value, an index value can serve as a retrieval key. In some embodiments, a retrieval key is a composite key, i.e., a combination of a key value from a first column and a key value from a second column, which together form a unique value.

According to the disclosed embodiments, backup system 140 generates metadata that facilitates join operations between tables. These tables may originate from the same database 120 or from different databases (e.g., 120-1 or 120-2), which can be of the same or different types. The metadata includes the content category of each column in every table within database 120. In one embodiment, categorizing the content involves prompting a large language model (LLM) with the contents of each column to generate a description of the data. This generated description is then used as the unified column name, ensuring a consistent naming convention across different tables. It is important to note that while the original column name remains unchanged in the source data, the unified name serves as a common designation for identifying columns that can be joined.

For example, columns that contain residential addresses in different tables may be labeled as “home address,” “place of residency,” or “mailing address.” While the format of the content may be similar, or perhaps even identical, an LLM would classify the contents of these columns under the same description. This information could then be processed using the LLM for classification. An example prompt may include: “What would be a category for a column in a database having the following column values: 150 Morristown rd., Basking Ridge, NJ; 201. Broadway Ave, NY; 130 main street, Springfield NJ”

In one embodiment, the same prompt and the same large language model (LLM) are utilized to unify the column names, ensuring consistent results. An LLM can include, but is not limited to, various models such as GPT-4 (OpenAI), Claude (Anthropic), Gemini (Google), and LLAMA (Meta). In an embodiment, the prompt may be a preconfigured template in which the variable parts are the contents of the columns. In one example, only a subset of the values from a column is included in the prompt provided to the LLM. This approach improves response time and decreases the computational resources required by the LLM. The LLM may be operated by a generative AI system, which in one embodiment, is external to backup system 140 and is accessed via an API.

The disclosed embodiments include normalizing the values in columns. This normalization is carried out using a function selected based on the category assigned to each column. For instance, columns that represent dates are standardized to a uniform format (DD, MM, YYYY). In one embodiment, the normalization function can be executed by an LLM by providing an appropriate prompt or via dedicated normalization processes.

In one embodiment, the original column names and their corresponding unified column names are stored as metadata for the backup table. Additionally, both the original values and their normalized equivalents are saved in the database backup. Alternatively, the normalized values can be stored in the backup, while a reverse normalization function may be included in the backup metadata to allow recovery of the original values. As previously mentioned, the database backup can include multiple backup files, each formatted as a column-oriented data file.

In one embodiment, the database backup includes unified column names and normalized column values, which are used to perform join operations among database tables. These tables can belong to the same or different types of databases. To this end, a user operating a user device 150 (e.g., a laptop, personal computer, or smartphone) selects at least one table to perform a join operation on. Access to the backup system 140 is provided, for example, via a web portal. It should be noted that NoSQL databases do not natively maintain data in tables; however, according to the disclosed embodiments, data from NoSQL databases is stored in a table format that users can access. For example, in MongoDB, a collection of documents is converted into rows, where common fields become columns and any remaining fields are consolidated into a final column. Furthermore, the unified column names, normalized values, and computed hash values are used to construct a join graph that maps relationships among tables, thereby enabling automated path discovery.

In an embodiment, the process begins by searching for joinable columns. A joinable column is one found in backup files that belongs to a table different from the input table. In this context, a joinable column must be of the same type and share values with at least one column in the input table. To locate joinable columns, a similarity hash is employed. Specifically, a number of searchable values (denoted as ‘n’) are computed using a hash function, such as a MinHash function. In this case, ‘n’ can be a preconfigured parameter (e.g., n=1000), a percentage of the total number of values in the column (e.g., n=5%), or a combination thereof. In this embodiment, hash values are computed based on the normalized values and may be saved in backup files. In an embodiment, the parameter ‘n’ is set based on the size of a table; that is, the more entries in the table, the higher the value of ‘n’. Therefore, different tables may have different values for n. A similarity search is then conducted to identify whether two columns from different tables have at least ‘k’ matching hash values. The parameter ‘k’ is a pre-configured number that is smaller than the value of ‘n’. If two or more columns share similar ‘k’ hash values, they are considered joinable columns. These pairwise joinable relationships form the basis for constructing the overall join graph, which captures multi-step relationships across tables.

In an embodiment, the similarity search for joinable columns is performed on columns of the same category (e.g., date, last name, etc.), which provides a faster response and reduces the computational resources consumed by backup system 140. In some embodiments, the similarity search is performed on the tables stored in the backups, with hash values computed during the backup process.

In one embodiment, backup system 140 maintains a map, referred to as a “hash map,” which associates hash values with a list of tables that include the corresponding hash value. When a new column is added, the backup system 140 computes the hash values for that column. Using the hash map, the system identifies tables that may include values similar to those in the new column and checks the intersecting columns in these tables to determine if they share ‘k’ common values. This process enables a fast search for joinable columns.

Backup system 140 performs a join operation between tables that contain joinable columns. The resulting joined tables from such operations can be saved in backup files 145. In an embodiment, users can query or perform other operations on the joined tables. In some configurations, if no joinable columns are found, backup system 140 informs the user that a join operation cannot be performed. In some embodiments, the system leverages the previously constructed join graph to automatically determine an optimal composite join path spanning multiple tables.

In one embodiment, a user can use their device (user device 150) to query which tables can be joined with a specified input table. In response, backup system 140 provides a list of candidate tables that are compatible for joining with the given input table. Additionally, backup system 140 may automatically traverse the join graph to generate a composite query that reflects the best join path based on the user's specified criteria, thereby simplifying the retrieval of integrated information from multiple tables.

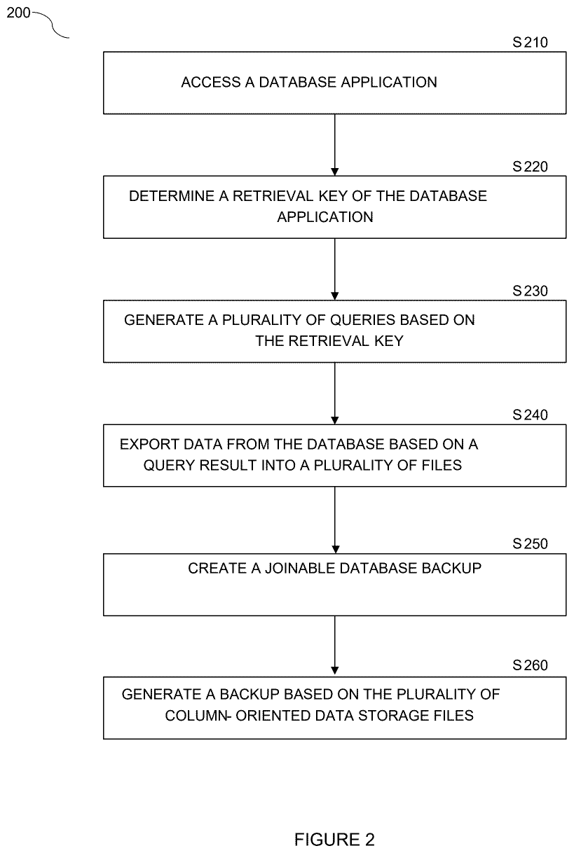

FIG. 2 is a flowchart of a method 200 for generating a database backup and performing data normalization, in accordance with an embodiment of the present disclosure.

The method 200 may be performed by the backup system 140. In an embodiment, generating a database backup includes generating a backup of the machine hosting the database (excluding the actual database data) and generating a backup of the data of the database as two distinct backups.

At S210, a database application is accessed. In an embodiment, accessing a database application includes detecting a database application deployed in a computing environment, such as a cloud computing environment. According to some embodiments, accessing a database application includes receiving a token, a credential, a combination thereof, and the like, to access the database. In an embodiment, accessing the database application includes accessing a machine, a workload, and the like, on which the database application is deployed.

According to certain embodiments, the database application is a stand-alone database application deployed on a virtual machine. The database application may include an SQL database or a NoSQL database. Examples of NoSQL databases include MongoDB® and CouchDB®. Examples of SQL databases include PostgreSQL, MySQL, MSSQL, and the like. It should be noted that the backup process is performed for any type of database application. That is, the same process can be performed for SQL, NoSQL, or any other type of database application.

NoSQL databases use different terminology than SQL (relational) databases for the data they store. For example, in SQL databases, a “table” corresponds to a “collection,” a “row” is similar to a “document,” a “column” is equivalent to a “field,” and a “primary key” is represented by an “ID,” which serves as the default unique identifier. This description will primarily employ terminology from SQL databases for clarity, but the disclosed embodiments are not limited to these types of databases.

At S220, a retrieval key of the database is determined. In some embodiments, the retrieval key is an index of rows, for example. The retrieval key may include a value assigned to each row, which is a unique value, such that no two rows include the same value of the retrieval key.

In some embodiments, a retrieval key is generated based on a composite of multiple-column identifiers. For example, in an embodiment, two identifiers, each of a distinct column, form a retrieval key together. In certain embodiments, a plurality of retrieval keys is selected, each retrieval key corresponding to a table of the database.

At S230, data is exported from the database. The exported data may include at least tables and their contents. In an embodiment, exporting data from the database includes generating a plurality of queries. In an embodiment, the plurality of queries is generated, each based on a value range of the retrieval key. For example, in an embodiment, a first query of the plurality of queries is generated based on a value range of ‘0’ to ‘10,000’ of the retrieval key, and a second query of the plurality of queries is generated based on a value range of ‘10,001’ to ‘20,000’. In an embodiment, there is no overlap between the values of the retrieval key for each of the generated queries.

In an embodiment, the query is generated in a query language, such as SQL. In an embodiment, data is exported from the database utilizing a logical backup. For example, in a PostgreSQL database, a pg_dump command is utilized to export data from a database application to a logical backup. According to an embodiment, a logical backup includes schema and data such as query language (e.g., SQL) commands, binary format, and the like. In an embodiment, a logical backup is a consistent snapshot, as opposed to a physical backup, which includes, for example, configuration files, raw files, directories, etc. As another example, in MongoDB, an export command, mongoexport, can be utilized to export collections (tables).

At S240, a plurality of backup files is generated. In an embodiment, the plurality of backup files is generated in a column-oriented data format, such as Apache® Parquet. In some embodiments, the plurality of backup files is generated such that a file, a group of files, etc., corresponds to a result of executing a query of the plurality of queries. Thus, data is exported from the database into a plurality of backup files.

In an embodiment, data is exported from the database application into the plurality of backup files by generating the plurality of queries, executing each query on the database, receiving a result for each query, and storing the results as data files in a column-oriented data format.

In some embodiments, for example, where a logical backup is generated (e.g., utilizing pg_dump command), the plurality of backup files is generated by converting the logical backup into a plurality of column-oriented data format files.

In some embodiments, for example, when collections are exported (e.g., utilizing mongoexport/or mongodump command), the plurality of backup files are generated by converting the logical backup into a plurality of column-oriented data format files.

At S250, a process for generating a database backup that supports join operations (referred to as a “joinable backup”) is performed. This process is executed on all exported backup files and includes unifying column names, normalizing column values, and computing hash values for similarity searches. In some embodiments, additional metadata for join graph construction, such as unified column mappings and pre-computed join relationships, is also generated at this step to facilitate automated path discovery in later processes.

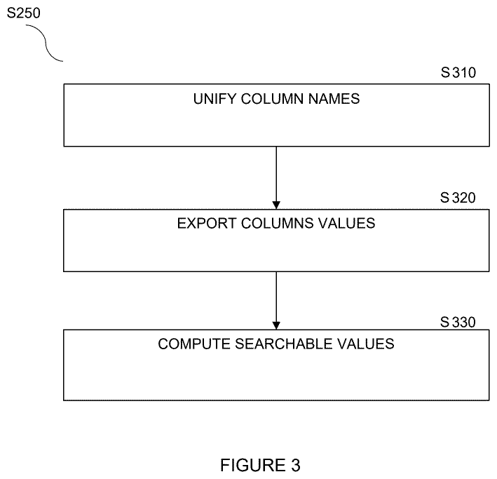

Reference is now made to FIG. 3, which illustrates the process of S250 for generating a joinable backup according to an embodiment. FIG. 3 may be executed by the backup system 140.

At S310, the names of the columns in an exported table are standardized or unified. This process involves prompting a large language model (LLM) with the contents of each column to determine the appropriate category for that column. An example of such a prompt is provided above. Additionally, the original column name and its corresponding standardized name are stored in the metadata of the backup. In one embodiment, these unified names are later used to construct a join graph that identifies possible paths for multi-step join operations across multiple tables.

At S320, the values in an exported table are normalized. This normalization process can be carried out using a normalization function, a large language model (LLM), or a combination of both. The specific normalization function and/or the prompt given to the LLM is selected based on the category of each respective column.

For instance, a normalization function may involve several tasks, such as converting date values to a consistent format, standardizing physical addresses to USPS format, or reformatting personal names to follow the structure “Last Name, First Name,” among others.

In an example embodiment, when employing an LLM for normalization, the prompt will include the type of category, a description of the requested format, and the contents of the column that need to be normalized. For example, the instruction might be to change the following date values to the format “DD, MM, YYYY.” A template for such a prompt may be preconfigured for ease of use.

In an embodiment, original column values and their respective normalized values' names are saved in the backup. In another embodiment, only the normalized values are saved in the backup, while the reverse normalization function is backup metadata. The reverse normalization function, when executed, returns the normalized values to their exact original values. That is, there is no data loss in the normalization process.

The following is an example demonstrating the operation of S240 and S250. Tables 1.1 and 1.2 are shown.

TABLE 1.1

| Computer | | |
|---|---|---|
| Name | IP Address | CPU Type |
| PC-001 | 192.168.1.1 | Intel i5 |
| PC-002 | 192.168.1.2 | Intel i7 |
| PC-003 | 192.168.1.3 | AMD Ryzen 5 |
| PC-004 | 192.168.1.4 | AMD Ryzen 7 |
| PC-005 | 192.168.1.5 | Intel i9 |
| PC-006 | 192.168.1.6 | AMD Ryzen 9 |
| PC-007 | 192.168.1.7 | Intel Xeon |
| PC-008 | 192.168.1.8 | AMD EPYC |
| PC-009 | 192.168.1.9 | Apple M1 |
| PC-010 | 192.168.1.10 | Apple M2 |

TABLE 1.2

| Hexadecimal IP | Memory |
|---|---|
| Address | Size |
| C0A80101 | 64 GB |
| C0A80102 | 32 GB |
| C0A80103 | 32 GB |
| C0A80104 | 8 GB |
| C0A80105 | 128 GB |
| 0A000001 | 64 GB |
| 0A000002 | 8 GB |

For example, when querying a language model, the column names “IP Address” and “Hexadecimal IP Address” are classified under the broader category of “Network Address.” The normalization function may involve converting the Hexadecimal IP Address into a standard IP address format. After unifying the column names and normalizing their values, the resulting tables are designated as Tables 2.1 and 2.2. The normalization process converts hexadecimal values to their decimal equivalents.

TABLE 2.1

| Computer | Network | |
|---|---|---|
| Name | Address | CPU Type |
| PC-001 | 192.168.1.1 | Intel i5 |
| PC-002 | 192.168.1.2 | Intel i7 |
| PC-003 | 192.168.1.3 | AMD Ryzen 5 |
| PC-004 | 192.168.1.4 | AMD Ryzen 7 |
| PC-005 | 192.168.1.5 | Intel i9 |
| PC-006 | 192.168.1.6 | AMD Ryzen 9 |
| PC-007 | 192.168.1.7 | Intel Xeon |
| PC-008 | 192.168.1.8 | AMD EPYC |
| PC-009 | 192.168.1.9 | Apple M1 |
| PC-010 | 192.168.1.10 | Apple M2 |

TABLE 2.2

| Network | Memory |
|---|---|
| Address | Size |
| 192.168.1.1 | 64 GB |
| 192.168.1.2 | 32 GB |
| 192.168.1.3 | 32 GB |
| 192.168.1.4 | 8 GB |
| 192.168.1.5 | 128 GB |
| 10.0.0.1 | 64 GB |
| 10.0.0.2 | 8 GB |

At S330, searchable values are computed for a predefined number (‘n’) of column values in each column. In an embodiment, the searchable values are computed over all normalized values in a column, where, from the calculated value, a set of (‘n’) values are selected as the searchable values.

In an embodiment, for each table column, a set of (‘n) values are the minimal hash values in the column that are kept, e.g., in the memory of backup system 140. To this end, a MinHash function is applied to normalized values in a column, where each hash value is a number. Then, a number of ‘n’ minimal (smallest) hash values are calculated or otherwise selected on all the rows. By choosing minimal hash values, similar tables will represent a large number of identical hash values in a set of ‘n’ values. A MinHash function is a probabilistic function used to efficiently estimate the Jaccard similarity between two sets. For example, applying a MinHash function on Tables 2.1 and 2.2 and selecting n=5 would result in two identical values between these tables.

It should be noted that searchable values can be computed on any range of values in a column, not just the first ‘n’ values, as demonstrated in the example above.

Referring to FIG. 2, a database backup is generated at S260. In this embodiment, the backup is created using multiple backup files. These files contain data exported from the databases as well as joinable data, as explained in FIG. 3. In some instances, the backup includes information such as a timestamp, a version identifier, reverse normalization functions, and original column names. This information indicates the date, time, or a combination of both when the backup was created. The data backup can be used to restore the database when needed.

It should be noted that S260 provides a data backup, in contrast to, for example, a machine backup. In some embodiments, the data backup includes a data structure, such as metadata of the database, a data schema of the database, table data, a store procedure, a view, a combination thereof, and the like. In an embodiment, database data (e.g., schema, views, store procedures, etc.) is extracted from a dump, for example, utilizing pg_dump, without storing the data itself. Thus, a pg_dump command can be utilized to generate the data files in a first format that can be converted to, for example, files in a Parquet format.

It should be noted that the process described in FIG. 2 is performed for each table and database application to be backed up. It should be further noted that a data backup is not the same as a storage backup. In a storage backup, a block-for-block copy of the storage device is created, which includes the database data and numerous files that are not useful for the actual database application, such as temporary files. It is, therefore, advantageous to store a backup only of the data of the database, without all the unnecessary files, folders, etc. which are not essential for the database to function properly.

In certain embodiments, these unified column names, normalized values, and minimal hash sets are used not only for direct join operations but also for building a join graph, which captures multi-step relationships across tables. This join graph is further leveraged to discover and automate complex query paths, as described in subsequent sections herein.

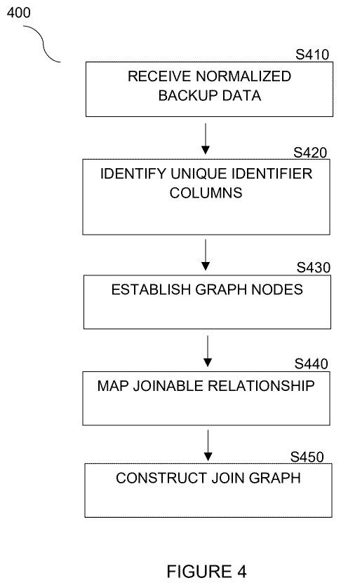

FIG. 4 is a flowchart of a method for constructing a join graph from normalized backup data, in accordance with an embodiment of the present disclosure. The method 400 may be performed by a backup system, such as backup system 140, which has further generated and received normalized backup data as described above (e.g. from the processes of FIGS. 2 and 3).

At S410, the normalized backup data is received from one or more data sources. The normalized backup data may include the tables (or collections) that have undergone column unification, value normalization, and, optionally, the computation of searchable hash values. The normalized backup data may be received automatically upon completion of the backup process, or in response to a user request via a user device (e.g., user device 150).

At S420, unique identifier columns, or column groups, are identified within the received data. In some embodiments, it is determined whether each column contains values that are substantially unique, such as Social Security numbers, credit card numbers, or even combinations of multiple columns (e.g., first name+last name+address). This identification may be carried out using a statistical analysis of value repetition, or by prompting a large language model (LLM) to interpret semantic clues in the column metadata. The ability to detect unique identifier columns streamlines join operations by highlighting the columns that can link records across different tables.

At S430, graph nodes corresponding to these unique identifier columns are established. For example, each column (or composite of columns) that meets the uniqueness criteria may be represented as a node in a graph data structure, enabling the system to build a network of potential linkages across multiple tables. In some embodiments, the system may also generate additional nodes to represent each table and then associate those table-nodes with their unique identifier columns. This arrangement enhances the efficiency of discovering multi-hop join paths by reducing the computational overhead involved in query generation.

At S440, joinable relationships are mapped by comparing precomputed similarity-based metadata. Specifically, in an embodiment, S440 may include comparing the MinHash signatures derived from the normalized row data of each column. For example, it is checked whether the sets of hash values for two columns have sufficient overlap (i.e., if the number of common hash values meets or exceeds a threshold “k”) to be considered joinable. If the threshold is satisfied, the system generates an edge in the graph to reflect this as a join relationship. In some embodiments, the semantic category of each column is also considered to ensure that only columns of the same or compatible categories are linked, thereby preventing irrelevant joins. Semantic categories may include, for example, “email address,” “date,” or “network address”.

At S450, the join graph is constructed by consolidating all identified nodes (unique identifier columns) and edges (joinable relationships) into a cohesive data structure. In one embodiment, the join graph is implemented using standard data structures (such as adjacency lists or matrices) and is maintained to facilitate automated multi-hop join query generation. By storing and managing this graph, automated discovery of valid multi-step join paths is enabled so that users can request data spanning multiple tables without manually tracking which columns can be joined.

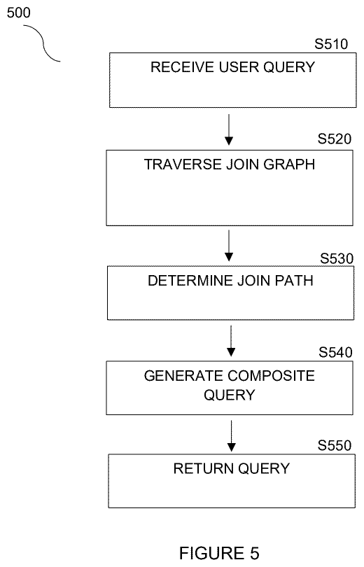

FIG. 5 is a flowchart of a method for generating a composite query based on a user input, in accordance with an embodiment of the present disclosure. The method may be performed by a backup system, such as backup system 140, which has access to the join graph previously created (e.g. in FIG. 4). The composite query is generated based on traversing the join graph.

At S510, a user query specifying the data that the user wishes to retrieve from the back-up database is received. This query may input by a user device (e.g., user device 150) via a web portal or application programming interface (API), and may include parameters such as desired columns, filter parameters, or other criteria.

At S520, the join graph is traversed to locate potential paths connecting the requested data elements. In some embodiments, a graph traversal algorithm is employed to identify multi-hop join paths by evaluating the connectivity of unique identifier nodes and their associated edges. This approach leverages the join graph to automatically determine valid sequences of join operations that connect the columns containing the requested data.

At S530, a join path is determined by traversing the join graph to identify a route connecting the tables that contain the data requested by the user. For example, S530 may include identifying a join path that links a user's personal information in one table to payment data in a second table and to transaction records in a third table, with the selection based on relationships established in the join graph. This graph-based, multi-hop join query generation is supported by the structure of the join graph generated in S450.

At S540, a composite query that unifies the relevant tables is generated. In an embodiment, this composite query may be produced in a format compatible with SQL, NoSQL, or another query language, depending on the particulars of the backed-up databases.

At S550, the query (or, in some configurations, the query's results) to the user device or another requesting entity is returned. By automating the discovery of multi-step join paths, this approach reduces the need for manual table correlation and significantly streamlines complex cross-database queries within a backup environment.

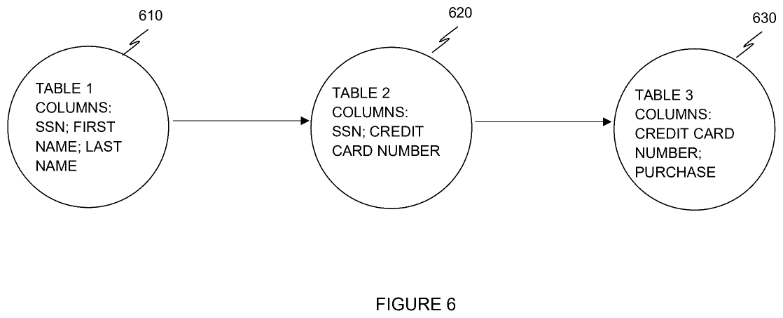

FIG. 6 is a diagram illustrating a join graph in which nodes represent unique identifier columns and arrows represent the direction of traversal between joinable columns, in accordance with an embodiment of the present disclosure. As shown, nodes 610, 620, and 630 are arranged from left to right, with an arrow extending from node 610 to node 620 and another arrow from node 620 to node 630. In one example embodiment, node 610 may correspond to a table containing columns such as “SSN, First Name, Last Name,” node 620 may correspond to a table containing columns such as “SSN, Credit Card Number,” and node 630 may correspond to a table containing columns such as “Credit Card Number, Purchase.” The arrows indicate that the SSN in node 610 is joinable with the SSN in node 620, thereby enabling the backup system to retrieve a matching credit card number from the second table. The credit card number, in turn, serves as a unique identifier that links node 620 to node 630, ultimately allowing the system to retrieve purchase details from the third table. By chaining these relationships in the join graph, the backup system can automatically determine a multi-step path from the SSN in node 610 to the purchase data in node 630 without requiring the user to manually correlate intermediate columns or specify multiple join statements. For example, based on the join graph, the system may automatically composite a query to retrieve data spanning these tables. In one embodiment, the backup system composites a query by joining Table1 and Table2 on the condition that Table1's SSN equals Table2's SSN, and then joining the resulting intermediate table with Table3 on the condition that Table2's Credit Card Number equals Table3's Credit Card Number, thereby automatically traversing the multi-hop join path defined by the graph.

In another example, when a user wishes to retrieve a person's first name, last name, and a list of their purchases. The backup system 140 first determines that the first and last names are stored in a table represented by node 610, while the purchase details reside in a table corresponding to node 630. Since these two tables do not directly share a common joinable column, the backup system 140 consults the join graph and identifies an intermediate relationship via node 620, where a unique identifier (such as SSN or a credit card number) is present. The backup system 140 then automatically composites a multi-step query: it extracts the first name and last name fields from the table at node 610, joins this data with the table at node 620 using the matching SSN, and finally joins the resulting dataset with the table at node 630 using the common credit card number.

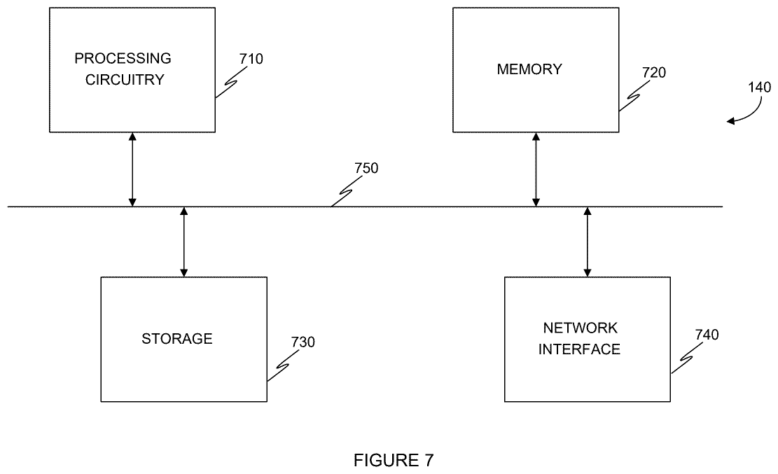

FIG. 7 is an example schematic diagram of a backup system 140 according to an embodiment. The backup system 140 includes, according to an embodiment, processing circuitry 710 coupled to a memory 720, a storage 730, and a network interface 740. In an embodiment, the components of the backup system 140 are communicatively connected via a bus 750.

In certain embodiments, the processing circuitry 710 is realized as one or more hardware logic components and circuits. For example, according to an embodiment, illustrative types of hardware logic components include field programmable gate arrays (FPGAs), application-specific integrated circuits (ASICs), application-specific standard products (ASSPs), system-on-a-chip systems (SOCs), graphics processing units (GPUs), tensor processing units (TPUs), Artificial Intelligence (AI) accelerators, general-purpose microprocessors, microcontrollers, digital signal processors (DSPs), and the like, or any other hardware logic components that are configured to perform calculations or other manipulations of information. The processing circuitry 710 is configured to operate as a generative AI system to execute, train, and/or perform inference on any type of language model. In some embodiments, the processing circuitry 710 is further configured to compute similarity metrics (e.g., MinHash), build a join graph of unique identifier columns, and generate composite queries as described herein.

In at least some embodiments, the processing circuitry 710 is configured to execute generative artificial intelligence (genAI) models, perform inferences using or otherwise apply genAI models, train genAI models, fine-tune genAI models, combinations thereof, and the like. Such genAI models are configured to produce text, images, videos, or other forms of data, and may include, but are not limited to, language models (for example, but not limited to, large language models, small language models, etc.), text-to-image artificial intelligence (AI) image generation systems, text-to-video Al video generators, combinations thereof, and the like. To this end, the processing circuitry 710 may be adapted to realize a transformer deep learning architecture (e.g., a generative pre-trained transformer [GPT], bidirectional encoder representations from transformers [BERT], text-to-text transfer transformer [T5], etc.) or a diffusion model, both, and the like.

In accordance with various such embodiments, the hardware utilized for the processing circuitry 710 is selected in order to enable genAI functionality based on factors such as, but not limited to, parallelism (e.g., amounts of parallel processing to be performed), memory demands (e.g., amounts of random access memory [RAM] utilized to store model weights and training during processing or video RAM [VRAM] to support large language models), clock speeds, thread counts, storage (for example, to support certain amounts of storage or storage speeds), cooling (e.g., liquid cooling or air cooling systems), power supply (e.g., to enable a target wattage used for certain kinds of activities), networking and connectivity (e.g., to support seamless data transfer for deployments involving communications between or among multiple machines or clusters), combinations thereof, and the like.

In embodiments that utilize large language models (LLMs) or otherwise perform operations that may require or be enhanced through the use of parallel processing, the processing circuitry 710 may include one or more GPUs or other processing units suitable for parallel processing. Such GPUs may be configured to perform matrix multiplication operations including, but not limited to, performing dot product operations in order to support neural network operations (for example, by performing dot product operations for hidden layer computations) or performing dot product operations in an attention mechanism to compute a similarity score between vectors during attention weight computation. In at least some such embodiments using GPUs, the processing circuitry 710 may include a number of CPU cores that is equal to or greater than the number of GPUs in order to facilitate or otherwise support parallel processing via multiple GPUs.

In an embodiment, the memory 720 is a volatile memory (e.g., random access memory, etc.), a non-volatile memory (e.g., read-only memory, flash memory, etc.), a combination thereof, and the like. In some embodiments, the memory 720 is an on-chip memory, an off-chip memory, a combination thereof, and the like. In certain embodiments, the memory 720 is a scratch-pad memory for the processing circuitry 710. Additionally, the memory 720 may store data structures (e.g., the join graph) that enable multi-step path discovery among tables in the backup environment.

In one configuration, software for implementing one or more embodiments disclosed herein is stored in the storage 730, in the memory 720, in a combination thereof, and the like. Software shall be construed broadly to mean any type of instructions, whether referred to as software, firmware, middleware, microcode, hardware description language, or otherwise. Instructions include, according to an embodiment, code (e.g., in source code format, binary code format, executable code format, or any other suitable format of code). The instructions, when executed by the processing circuitry 710, cause the processing circuitry 710 to perform the various processes described herein, in accordance with an embodiment.

In some embodiments, the storage 730 is a magnetic storage, an optical storage, a solid-state storage, a combination thereof, and the like, and is realized, according to an embodiment, as a flash memory, as a hard disk drive, another memory technology, various combinations thereof, or any other medium which can be used to store the desired information. The storage 730 may hold large-scale backup files, normalized data, and associated metadata, such as MinHash signatures, enabling the system to detect joinable columns across multiple databases.

The network interface 740 is configured to provide the backup system 140 with communication with, for example, the network 130, workload 110, database application 120, etc., according to an embodiment. In some embodiments, the network interface 740 may receive user queries requesting data from multiple tables, prompting the processing circuitry 710 to traverse the join graph and produce a composite query.

It should be understood that the embodiments described herein are not limited to the specific architecture illustrated in FIG. 7, and other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer-readable medium consisting of parts, or certain devices and/or a combination of devices. The application program may be uploaded to, and executed by, a machine comprising any suitable architecture. Preferably, the machine is implemented on a computer platform having hardware such as one or more processing units (“PUs”), a memory, and input/output interfaces. The computer platform may also include an operating system and microinstruction code. The various processes and functions described herein may be either part of the microinstruction code or part of the application program, or any combination thereof, which may be executed by a PU, whether or not such a computer or processor is explicitly shown. In addition, various other peripheral units may be connected to the computer platform such as an additional data storage unit and a printing unit. Furthermore, a non-transitory computer-readable medium is any computer-readable medium except for a transitory propagating signal.

All examples and conditional language recited herein are intended for pedagogical purposes to aid the reader in understanding the principles of the disclosed embodiment and the concepts contributed by the inventor to furthering the art and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to the first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for constructing a join graph from normalized data, the method comprising:
receiving normalized data derived from a plurality of database tables, wherein the normalized data corresponds to columns that have been standardized to a format across the plurality of database tables;
identifying one or more unique identifier columns among the plurality of database tables in the normalized data, wherein each unique identifier column includes values that enable matching of data across the plurality of database tables;
generating a plurality of graph nodes, each node corresponding to at least one of the plurality of database tables;
mapping joinable relationships between the graph nodes based on the unique identifier columns; and
generating a join graph based on the mapped joinable relationships.

2. The method of claim 1, further comprising:
storing metadata for each standardized column, wherein the metadata includes at least one of: an original column name for the column, and a normalizing rule applied to the column.

3. The method of claim 1, further comprising:
computing hash-based signatures for at least two columns in the normalized data and designating the columns as unique identifier columns upon determining that the columns share a threshold overlap in their computed hash-based signatures.

4. The method of claim 1, further comprising:
receiving a query referencing multiple tables in the normalized data, traversing the join graph to find a multi-hop path between at least two of the graph nodes, and returning joined query results based on a multi-hop path.

5. The method of claim 1, further comprising:
dividing at least one large database table into multiple subsets in the normalized data, each subset corresponding to a distinct range of retrieval key values.

6. The method of claim 1, further comprising:
storing the generated join graph along with the normalized data in a backup repository, thereby enabling subsequent queries to reuse the join graph.

7. The method of claim 1, wherein identifying the one or more unique identifier columns includes detecting columns with personally identifiable information for enabling record matching across multiple tables.

8. The method of claim 1, further comprising:
applying a large language model or generative AI system to determine standardized column categories prior to receiving the normalized data.

9. The method of claim 1, further comprising:
normalizing columns originating from at least one relational database and at least one non-relational database to unify columns for cross-database join operations.

10. The method of claim 1, further comprising:
creating a joined table by merging data from multiple nodes in the join graph and storing the joined table in a same repository as the normalized data.

11. A non-transitory computer-readable medium storing a set of instructions for constructing a join graph from normalized data, the set of instructions comprising:
one or more instructions that, when executed by one or more processors of a device, cause the device to:
receive normalized data derived from a plurality of database tables, wherein the normalized data corresponds to columns that have been standardized to a format across the plurality of database tables;
identify one or more unique identifier columns among the plurality of database tables in the normalized data, wherein each unique identifier column includes values that enable matching of data across the plurality of database tables;
generate a plurality of graph nodes, each node corresponding to at least one of the plurality of database tables;
map joinable relationships between the graph nodes based on the unique identifier columns; and
generate a join graph based on the mapped joinable relationships.

12. A system for constructing a join graph from normalized data comprising:
one or more processors configured to:
receive normalized data derived from a plurality of database tables, wherein the normalized data corresponds to columns that have been standardized to a format across the plurality of database tables;
identify one or more unique identifier columns among the plurality of database tables in the normalized data, wherein each unique identifier column includes values that enable matching of data across the plurality of database tables;
generate a plurality of graph nodes, each node corresponding to at least one of the plurality of database tables;
map joinable relationships between the graph nodes based on the unique identifier columns; and
generate a join graph based on the mapped joinable relationships.

13. The system of claim 12, wherein the one or more processors are further configured to:
store metadata for each standardized column, wherein the metadata includes at least one of:
an original column name for the column, and a normalizing rule applied to the column.

14. The system of claim 12, wherein the one or more processors are further configured to:
compute hash-based signatures for at least two columns in the normalized data and designating the columns as unique identifier columns upon determining that the columns share a threshold overlap in their computed hash-based signatures.

15. The system of claim 12, wherein the one or more processors are further configured to:
receive a query referencing multiple tables in the normalized data, traversing the join graph to find a multi-hop path between at least two of the graph nodes, and returning joined query results based on a multi-hop path.

16. The system of claim 12, wherein the one or more processors are further configured to:
divide at least one large database table into multiple subsets in the normalized data, each subset corresponding to a distinct range of retrieval key values.

17. The system of claim 12, wherein the one or more processors are further configured to:
store the generated join graph along with the normalized data in a backup repository, thereby enabling subsequent queries to reuse the join graph.

18. The system of claim 12, wherein identifying the one or more unique identifier columns includes detecting columns with personally identifiable information for enabling record matching across multiple tables.

19. The system of claim 12, wherein the one or more processors are further configured to:
apply a large language model or generative AI system to determine standardized column categories prior to receiving the normalized data.

20. The system of claim 12, wherein the one or more processors are further configured to:
normalize columns originating from at least one relational database and at least one non-relational database to unify columns for cross-database join operations.

21. The system of claim 12, wherein the one or more processors are further configured to:
create a joined table by merging data from multiple nodes in the join graph and storing the joined table in a same repository as the normalized data.
